(19) United States
(12) Patent Application Publication
(10) Pub. No.: US 2019/0032330 A1
(43) Pub. Date: Jan. 31, 2019

(54) ENGINEERED RIGID ACOUSTICAL LOOSE LAY FLOORING

(71) Applicant: John J. Kunzler, Beaverton, OR (US)

(72) Inventor: John J. Kunzler, Beaverton, OR (US)

(21) Appl. No.: 15/996,111

(22) Filed: Jun. 1, 2018

Related U.S. Application Data
(60) Provisional application No. 62/538,521, filed on Jul. 28, 2017.
(60) Provisional application No. 62/591,664, filed on Nov. 28, 2017.

(51) Int. Cl. E04B 1/86; B32B 5/26; B60R 13/08

(52) U.S. Cl. CPC E04B 1/86; B32B 5/26; E04B 2001/8461; B32B 2307/10; B60R 13/08

(57) ABSTRACT

An apparatus, system, and method are disclosed for a loose-lay flooring. The loose-lay flooring includes a rigid core, a wear layer, and an anti-slip layer. The wear layer is dispose on a first side of the rigid core. The anti-slip layer is disposed on a second side of the rigid core.

### CROSS-REFERENCES TO RELATED APPLICATIONS

This application claims the benefit of U.S. Provisional Patent Application No. 62/538,521 entitled “ENGINEERED LOOSE-LAY FLOORING” and filed on 28 Jul. 2017 for John J. Kunzler, which is incorporated herein by reference. This application also claims the benefit of U.S. Provisional Patent Application No. 62/591,664 entitled “ENGINEERED LOOSE-LAY FLOORING” and filed on 28 Nov. 2017 for John J. Kunzler, which is incorporated herein by reference.

### FIELD

This invention relates to flooring and more particularly relates to engineered rigid acoustical looselay flooring.

### BACKGROUND

Various types of flooring exist, including carpet, tiles, concrete, and wood. Different types of flooring have different aesthetic and functional properties. Carpet may be soft but suffers in high traffic. Tile may be aesthetically attractive but can be cold and hard. Wood may also be aesthetically pleasing but may be expensive and suffers in high humidity or may be ruined by prolonged exposure to water and other liquids.

### SUMMARY

An apparatus is disclosed. The apparatus includes a loose-lay flooring. The loose-lay flooring includes a rigid core, a wear layer, and an anti-slip layer. The wear layer is dispose on a first side of the rigid core. The anti-slip layer is disposed on a second side of the rigid core.

A flooring apparatus is also disclosed. The flooring apparatus include a loose-lay flooring. The loose-lay flooring includes a tongue-and-groove arrangement. The loose-lay flooring includes a rigid core, a wear layer, and an anti-slip layer. The wear layer is disposed on a first side of the rigid core. The anti-slip layer is disposed on a second side of the rigid core.

A method is also disclosed. The method includes extruding a rigid core layer. The method also includes applying a wear layer, film layer and a balance layer to the rigid core layer to form a top portion. The method also includes cutting the top portion to a product size. The method also includes applying an anti-skid layer to the top portion.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 depicts a cross-sectional view of one embodiment of a loose-lay flooring in accordance with the present invention;

FIG. 2 illustrates a side view of one embodiment of a joint of a first flooring and a second flooring in accordance with the present invention;

FIG. 3 illustrates a side elevation view of one embodiment of a flooring having a tongue and groove in accordance with the present invention;

FIG. 4 illustrates a perspective view of one embodiment of an anti-slip layer of a loose-lay flooring in accordance with the present invention; and

FIG. 5 illustrates a flowchart of one embodiment of a method of manufacturing a flooring product in accordance with the present invention.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Embodiments described herein provide advantages over conventional flooring systems. In particular, embodiments described herein provide for greater ease of repair by facilitating removal of a damaged or defective part without necessitating removal of adhesives or removal of undamaged parts. Additionally, some embodiments described herein are tolerant of less-than-ideal laying surfaces. Some embodiments described herein demonstrate reduced expansion, contraction, and deformation. Some embodiments described herein provide acoustical properties to reduce or dismiss the need for an additional acoustical material or engineering. Some embodiments described herein provide for secure placement with reduced or no need for adhesives.

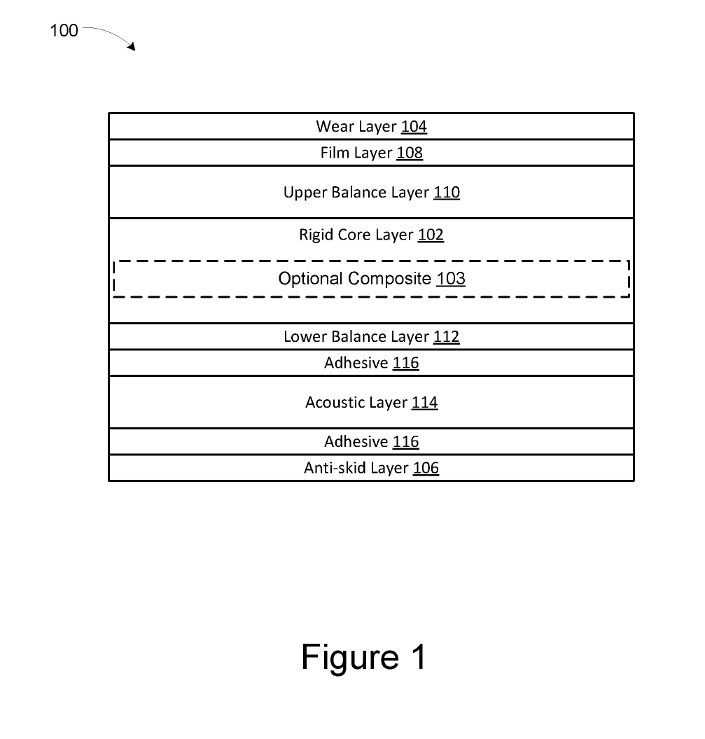

FIG. 1 depicts a cross-sectional view of one embodiment of a loose-lay flooring 100. The illustrated embodiment includes a rigid core layer 102. In some embodiments, the rigid core layer 102 forms the structural base or backbone of the flooring 100.

In some embodiments, the rigid core layer 102 includes an extruded material. In other embodiments, the rigid core layer 102 includes a molded material. For example, the rigid core layer 102 may include a compression or injection molded material. In some embodiments, the rigid core layer 102 includes materials that are stamped or formed by other manufacturing or shaping processes.

In some embodiments, the rigid core layer 102 includes one or more of a synthetic material and a natural material. In some embodiments, the rigid core layer 102 includes one or more of a plastic, wood, stone, and the like. In some embodiments, the rigid core layer 102 includes one or more of a stone powder, calcium carbonate, poly-vinyl chloride (PVC), and pigments. In some embodiments, the rigid core layer 102 includes 2.5-parts stone powder to one-part PVC powder. In some embodiments, the stone powder used in the rigid core layer 102 comprises calcium carbonate. In some embodiments, the rigid core layer 102 is phthalate free.

In some embodiments, the rigid core layer 102 includes a reduced amount of plasticizer agents. In other embodiments, the rigid core layer 102 includes no plasticizer agents. In some embodiments, the rigid core layer 102 includes a homogenous material. In other embodiments, the rigid core layer 102 includes a heterogeneous material. In some embodiments, the rigid core layer 102 includes a variable density material or structure. In other embodiments, the rigid core layer 102 includes a relatively high-density material.

In some embodiments, the rigid core layer 102 includes a composite 103. For example, the rigid core layer 102 may include a fiberglass portion. The composite 103 may also include a carbon fiber or other fibrous materials. In some embodiments, the composite is a sheet material or loose fabric. In some embodiments, the composite is impregnated with a matrix. In other embodiments, the rigid core layer 102 forms a portion or all of the matrix. In some embodiments, the composite is a loose fabric that is applied to an interior or exterior region of the rigid core layer 102. In other embodiments, the composite is a cut fiber or non-woven fabric. In some embodiments, the composite 103 is added to the rigid core layer 102 during, before, or after extrusion or another forming process.

In some embodiments, the composite 103 is applied to an exterior region of the rigid core layer 102. For example, the composite 103 may be applied to an exterior surface of the rigid core layer 102. The composite 103 may also be applied to other regions of the flooring 100. For example, the composite 103 may be applied to a balance layer, an acoustic layer, or other portions of the flooring 100.

In the illustrated embodiment, the loose-lay flooring 100 also includes a wear layer 104. In some embodiments, the wear layer 104 includes a plastic layer. For example, the wear layer 104 may include a poly-vinyl chloride (PVC). In some embodiments, the wear layer 104 includes a plastic composite. The wear layer 104 may include one or more plasticizers. In some embodiments, the wear layer 104 is a composite of PVC powder and one or more plasticizers.

In some embodiments, the wear layer 104 may include a top coat or finishing. In some embodiments, the wear layer 104 includes a urethane top finish. In other embodiments, the wear layer 104 includes a ceramic bead, urethane, or aluminum oxide top finish. In some embodiments, the wear layer 104 includes a traction texture or other structure to provide a contact or visual feature. Layer 104 wear layer may be micro-beveled to reduce unevenness at floor joints and enhance visuals.

In some embodiments, the wear layer 104 is transparent. In other embodiments, the wear layer 104 is opaque or semi-transparent. In some embodiments, the wear layer 104 has one or more regions that are fully transparent and one or more regions that are not fully transparent.

The illustrated embodiment also includes an anti-slip layer 106. In some embodiments, the anti-slip layer 106 includes one or more relatively high friction materials. For example, the anti-slip layer 106 may include synthetic or natural rubber, a vinyl foam, open or closed cell neoprene, a urethane sponge, and the like.

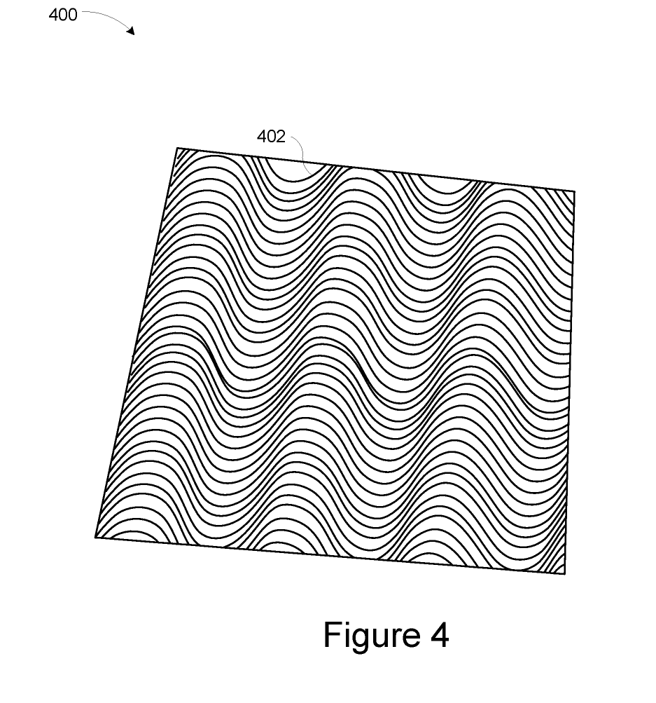

In some embodiments, the anti-slip layer 106 includes a surface structure. In some embodiments, the surface structure of the anti-slip layer 106 provides additional anti-slip properties. For example, the anti-slip layer 106 may include surface structures which provide friction in loose particulate or wet conditions. Additional detail is described below with reference to FIG. 4.

In some embodiments, the anti-slip layer 106 includes one or more internal structures to reduce slipping and slipping of the loose-lay flooring 100 relative to a mounting surface. In some embodiments, the anti-slip layer 106 includes an internal framework or element to reduce crushing of the anti-slip layer 106 under load or in a high traffic area.

In some embodiments, the anti-slip layer 106 is a film or coating. For example, the anti-slip layer 106 may be a material that is rolled, sprayed, or laid onto the flooring 100. In some embodiments the anti-slip layer 106 is urethane-based. The anti-slip layer 106 provides an increase to friction or resistance to movement of the flooring 100 similar to synthetic and/or natural rubbers and other anti-slip materials.

In some embodiments, the anti-slip layer 106 is applied to the core 102. In other embodiments, the anti-slip layer 106 is applied to a foam layer such as an irradiation crosslinked polyethylene (IXPE) foam or other single or variable density foam. In other embodiments, the anti-slip layer 106 is applied to the acoustic layer 114 or the lower balance layer 112 to facilitate omission of the intermediate layers and corresponding adhesives 116.

In some embodiments, the anti-slip layer 106 is applied to the flooring 100 as a final process on a finished assembly of the flooring 100. In other embodiments, the anti-slip layer 106 is applied to a component of the flooring 100 prior to final assembly. In some embodiments, the anti-slip layer 106 is applied to the flooring 100 or a component of the flooring 100 before a final cut or sizing is completed. In other embodiments, the anti-slip layer 106 is applied to the flooring 100 or component of the flooring 100 after a final cut or sizing is completed.

In some embodiments, the anti-slip layer 106 is a urethane formulation that is cured using a heatless curing process. For example, the anti-slip layer 106 may include a urethane formulation that is cured using a cold ultraviolet light curing process. In other embodiments, the anti-slip layer 106 is cured using a warm or heated curing process. For example, the anti-slip layer 106 may be cured using a warm or heated ultraviolet lamp curing process.

The illustrated embodiment of the loose-lay flooring 100 also includes a film layer 108. In some embodiments, the film layer 108 is an optional element in the loose-lay flooring 100. In some embodiments, the film layer 108 includes a decorative component. For example, the film layer 108 may include an image which is at least partially visible through the wear layer 104. In some embodiments, the film layer 108 includes an image which simulates a natural or synthetic material such as wood, stone, tile, and the like. In other embodiments, the film layer 108 forms a pattern. In some embodiments, the film layer 108 forms a pattern in conjunction with other portions placed next to the loose-lay flooring 100.

In some embodiments, the film layer 108 includes a texture. In some embodiments, the texture simulates a material textures such as a wood grain or texture, stone pores, tile edges, and the like. In some embodiments, the texture of the film layer 108 translates into the wear layer 104. In some embodiments, the texture is part of the rigid core layer 102 or another layer of the loose-lay flooring 100 and is translated to the film layer 108.

In some embodiments, the film layer 108 includes a plastic film. In some embodiments, the plastic film is a plastic composite. In some embodiments, the film layer 108 is part of the wear layer 104. For example, the film layer 108 may be a separate film or the film layer 108 may be formed on the back of the wear layer 104 via printing or other application processes. In some embodiments, the film layer 108 is bonded to the wear layer 104. For example, the film layer 108 may be bonded to the wear layer 104 through mechanical, thermal, or chemical bonding or through the application or adhesives.

The illustrated embodiment of the loose-lay flooring 100 also includes an upper balance layer 110. In some embodiments, the upper balance layer 110 is optional. In some embodiments, the upper balance layer 110 provides a physical characteristic. In some embodiments, the physical characteristic provided by the upper balance layer 110 is structural rigidity in one or more directions. In some embodiments, the upper balance layer 110 corresponds to a lower balance layer 112 described in greater detail below.

In some embodiments, the upper balance layer 110 includes a mesh or other material. In some embodiments, the upper balance layer 110 includes a material having a physical characteristic to reducing a bending or curling of the loose-lay flooring 100. In some embodiments, the upper balance layer 110 is bonded to the film layer 108. In some embodiments, the upper balance layer 110 is also bonded to the rigid core layer 102. In some embodiments, the upper balance layer 110 includes one or more of: PVC powder, plasticizer, and stone powder.

In the illustrated embodiment, the loose-lay flooring 100 includes a lower balance layer 112. In some embodiments, the loose-lay flooring 100 does not include a lower balance layer 112. In other words, in some embodiments, the lower balance layer 112 is optional. In some embodiments, the lower balance layer 112 is bonded to the rigid core layer 112. In other embodiments, the acoustical layer 114 is bonded to the rigid core layer 102. In some embodiments, the wear layer 104, the film layer 108, the upper balance layer 110, the rigid core layer 102, and the lower balance layer 112 are all bonded together. In some embodiments, these layers are bonded together in the same operation. In other embodiments, one or more of these layers are bonded separately from the others. In some embodiments, one or more of the wear layer 104, the film layer 108, the upper balance layer 110, the rigid core layer 102, and the lower balance layer 112 is bonded to another of the layers through an application of at least one of heat, pressure, and a chemical.

In some embodiments, the lower balance layer 112 includes a material having a physical characteristic complimentary to a physical characteristic of the upper balance layer 110. For example, the lower balance layer 112 may include one or more of PVC, calcium carbonate, plasticizers, and the like. In some embodiments, the lower balance layer 112 provides a structural effect to reduce bending and/or curling of the loose-lay flooring 100. In some embodiments, the lower balance layer 112 is a mesh, sheet, strap, or other material having one or more of a variety of geometries.

The illustrated embodiment of the loose-lay flooring 100 also includes an acoustic layer 114. In some embodiments, the acoustic layer 114 is a foam layer. In other embodiments, other materials, such as a composite, a woven fabric, a non-woven fabric, or other acoustic damping material, may be used.

In the illustrated embodiment, the acoustic layer 114 is bonded to the lower balance layer 112 with an adhesive 116. In some embodiments, the adhesive 116 includes a thermal, chemical, or mechanical adhesive. For example, the adhesive 116 may include an epoxy or other thermoset, a plastic, a melt-bonding agent, or other bonding substance or process.

In the illustrated embodiment, the anti-slip layer 106 is coupled to the acoustic layer 114 via another layer of the adhesive 116. In other embodiments, the anti-slip layer is coupled to the acoustic layer 114 via an application of at least one of heat and pressure. In some embodiments, the adhesive 116 is applied to at least one of the lower balance layer 112, the acoustic layer 114, and the anti-slip layer 106 in a uniform pattern. In other embodiments, the adhesive 116 is applied in a non-uniform pattern. For example, the adhesive 116 may be spread evenly on a layer, applied in dots or lines, or placed in greater concentrations to achieve a particular mechanical, thermal, or acoustic performance.

In some embodiments, one or more of the layers of the loose-lay flooring 100 are waterproof, insulated, cushioning, or the like. For example, in some embodiments, the adhesive 116 may be a waterproof adhesive.

In some embodiments, the loose-lay flooring 100 is formed to have one of a plurality of overall product thickness or height. For example, the loose-lay flooring 100 may have a 5.2 mm overall thickness or a 6.0 mm overall thickness. In some embodiments, the overall thickness of the loose-lay flooring 100 is achieved through uniform layer thicknesses. For example, in the 5.2 mm example, the wear layer 104 may be 0.3 mm in thickness, the rigid core layer 102 may be 3.0 mm in thickness, the lower balance layer 112 may be 0.9 mm in thickness, and the acoustic layer 114 in combination with the anti-skid layer 106 may be 1.0 mm in thickness. Each of these values are given as approximate examples. Other thicknesses or ratios may also be used.

In the 6.0 mm example, the wear layer 104 may be 0.5 mm in thickness, the upper balance layer 110 may be 0.8 mm in thickness, the rigid core layer 102 may be 2.8 mm in thickness, the lower balance layer 112 may be 0.9 mm in thickness, and the acoustic layer 114 in combination with the anti-skid layer 106 may be 1.0 mm in thickness. Each of these values are given as approximate examples. Other thicknesses or ratios may also be used.

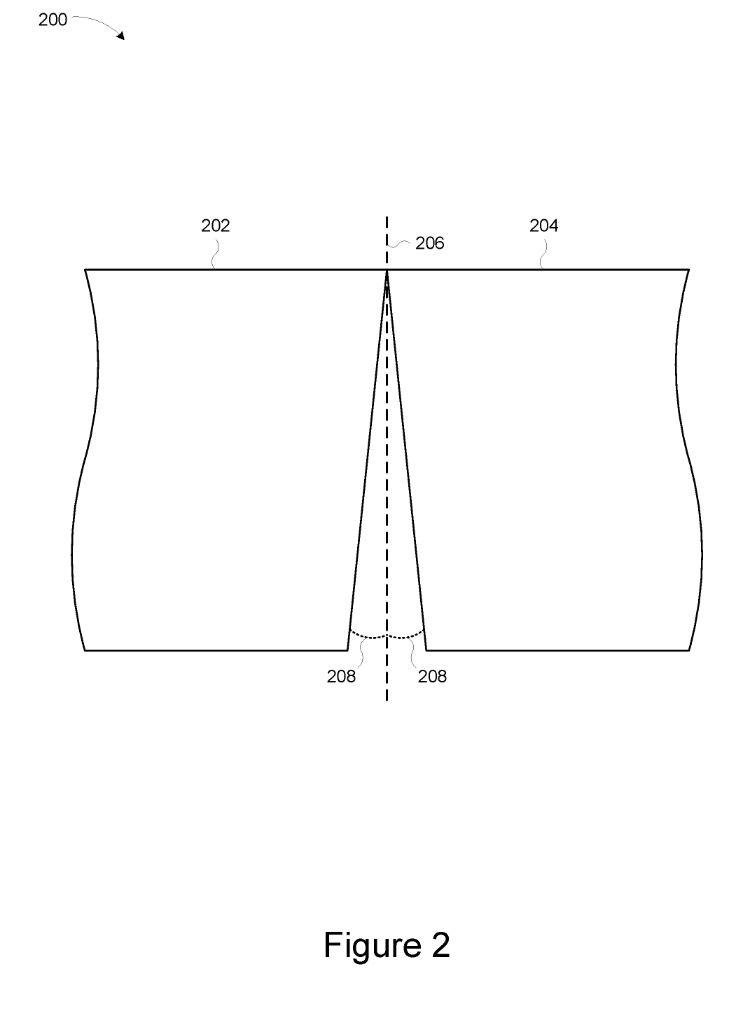

FIG. 2 illustrates a side view of one embodiment of a joint 200 of a first flooring 202 and a second flooring 204. In the illustrated embodiment, the joint 200 is a jointing of the first flooring 202 and the second flooring 204. In some embodiments, the first flooring 202 is a first component of a loose-lay flooring arrangement and the second flooring 204 is a second component of the loose-lay flooring arrangement. In some embodiments, the first flooring 202 and the second flooring 204 are substantially the same or similar components. In other embodiments, the first flooring 202 and the second flooring 204 are different or distinct from one another.

In some embodiments, the edges of the first flooring 202 and the second flooring 204 are a straight profile without a clicking or engaging structure to tie the first and second floorings 202 and 204 together. In some embodiments, the first and second floorings 202 and 204 are a glue-less flooring.

For example, the first flooring 202 and the second flooring 204 may be duplicates of one another. In another example, the first flooring 202 and the second flooring 204 may form a larger pattern made up of a plurality of flooring components placed randomly or in a specific pattern.

In the illustrated embodiment, the first flooring 202 and the second flooring 204 are joined at a vertical threshold 206. In the illustrated embodiment, both the first flooring 202 and the second flooring 204 include an edge angle 208. In some embodiments, the edge angle 208 is an angle from the anti-slip layer 106 of FIG. 1 to the wear layer 104 of FIG. 1.

In the illustrated embodiment, the edge angle 208 is shown as extending outward and upward from the bottom of the first flooring 202 and the second flooring 204, respectively. In some embodiments, this edge angle 208 facilitates a uniform and consistent fit

In other embodiments, the angle 208 is reversed with the top of the first flooring 202 and the second flooring 204 being smaller than the bottom. In some embodiments, this angled arrangement provides for a gapped joint to simulate tile grout or provide another visual or mechanical effect. In some embodiments, the angle 208 facilitates greater ease of installation.

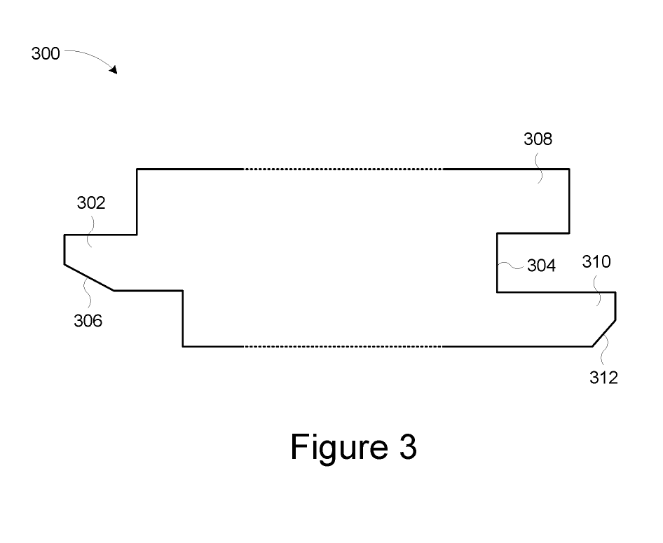

FIG. 3 illustrates a side elevation view of one embodiment of a flooring 300 having a tongue 302 and groove 304. In the illustrated embodiment, the tongue 302 is positioned approximately central to the flooring 300. In some embodiments, the tongue 302 may be formed nearer a top or bottom surface of the flooring 300. In the illustrated embodiment, the tongue 302 includes a chamfer 306 formed in a lower portion of the tongue 302. The chamfer 306 may improve ease of installation by reducing catching or snagging of the tongue 302 on the groove 304 of the adjoining flooring 300. The chamfer 306 may also provide additional clearance relative to the subfloor during installation of the flooring 300.

The tongue 302 may have a consistent size along a length of the flooring 300. In some embodiments, the tongue 302 may vary. For example, the tongue 302 may have a variation in size to accommodate, or force, a staggering of flooring 300 or other relative arrangements of the flooring 300. In the illustrated embodiment, the top portion of the tongue 302 is shorted than the bottom portion of the tongue 302. In other embodiments, the dimensions are the same or reversed.

In some embodiments, the tongue 302 may correspond to one or more of layers of the flooring 300 such as those illustrated in FIG. 1 and described above. For example, the tongue 302 may include a core layer or a portion of a core layer. The tongue 302 may include a coating or other layer included in or applied to the tongue 302.

The groove 304 of the flooring 300 is formed on the flooring opposite the tongue 302. The groove 304 may be formed between an upper portion 308 and a lower portion 310 of the flooring 300. In the illustrated embodiment, the groove 304 has a rectangular profile in which the upper portion 308 and the lower portion 310 are parallel. In some embodiments, the groove 304 has a non-rectangular profile.

Similar to the tongue 302, in some embodiments, the groove 304 (or at least one of the upper portion 308 and the lower portion 310) may correspond to a particular layer or group of layers that make up the flooring 300. For example, the upper portion 308 may correspond to or comprise the wear layer 104, the film layer 108, and the upper balance layer 110 while the lower portion 310 corresponds to or comprises the lower balance layer 112, the acoustic layer 114, and the anti-skid layer 106 of FIG. 1. In another example, at least one of the upper portion 308 and the lower portion 310 may include a portion of the rigid core layer 102 of FIG. 1. Other compositions and arrangements relative to the layup of the flooring 300 are also contemplated.

In some embodiments, the groove 304 may include a coating or other treatment. The coating may facilitate easy insertion of the tongue 302 of the adjoining flooring 300 into the groove. In some embodiments, the coating forms a bond or otherwise resists separation of the tongue 302 of the adjoining flooring 300 from the groove 304.

In the illustrated embodiment the groove 304 is parallel to a body of the flooring 300. In other embodiments, the groove 304 may be disposed at an upward or downward angle relative to the flooring 300. The upper portion 308 and the lower portion 310 may have parallel sides forming the groove 304. In some embodiments, the upper portion 308 and the lower portion 310 are non-parallel relative to one another. In some embodiments, the non-parallel relationship of the upper portion 308 and the lower portion 310 results in a tapered geometry in the groove 304. In some embodiments, the groove 304 includes a locking or other separation resistance feature to secure the tongue 302 of the adjoining flooring 300.

FIG. 4 illustrates a perspective view of one embodiment of an anti-slip layer 400 of a loose-lay flooring. In the illustrated embodiment, the anti-slip layer 400 includes a surface structure 402. In some embodiments, the surface structure 402 includes an embossed structure. In other embodiments, the surface structure 402 includes a molded structure. In some embodiments, the surface structure 402 includes a machined structure. In other embodiments, the surface structure 402 includes an etched structure. In other embodiments, the surface structure 402 includes a smooth-surfaced structure.

In some embodiments, the surface structure 402 is formed during an application of the anti-slip layer 400. For example, the surface structure 402 may be formed by a spray or roll-on pattern of a coating forming the anti-slip layer 400. In other embodiments, the surface structure 402 is formed by multiple applications or coats of the anti-slip layer 400. For example, a base layer may be applied with subsequent layers including a pattern or differential thickness in application. In other embodiments, stencils, etching, masking, phobic coatings, or the like are incorporated to create a smooth or variable structure in the anti-slip layer 400.

In some embodiments, the surface structure 402 is a unified portion of the anti-slip layer 400. In other embodiments, the surface structure 402 is a separate portion of the anti-slip layer 400. In some embodiments, the surface structure 402 is bonded or otherwise attached to the anti-slip layer 400. In some embodiments, the anti-slip layer 400 and the surface structure 402 include the same material. In other embodiments, the anti-slip layer 400 and the surface structure 402 include a different material.

In some embodiments, the anti-slip layer 400 includes a PVC material. In some embodiments, the anti-slip layer 400 includes a polyethylene material such as a IXPE material or the like. In some embodiments, the anti-slip layer 400 is a urethane-based formulation in a coating that is applied via rolling, spraying, laying, dipping or the like. In some embodiments, the anti-slip layer 400 includes other materials or application approaches.

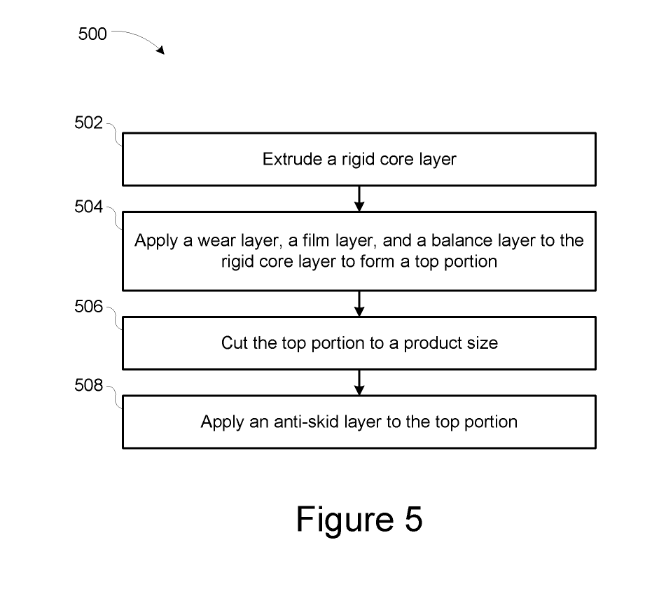

FIG. 5 illustrates a flowchart of one embodiment of a method 500 of manufacturing a flooring product. At block 502, the method 500 includes extruding a rigid core layer. In some embodiments, the rigid core layer includes one or more of a plastic, wood, stone, and the like. In some embodiments, the rigid core layer includes one or more of a stone powder, calcium carbonate, PVC, and pigments.

In some embodiments, the rigid core layer includes a homogenous material. In other embodiments, the rigid core layer includes a heterogeneous material. In some embodiments, the rigid core layer includes a variable density material or structure. In other embodiments, the rigid core layer includes a relatively high-density material.

In some embodiments, the rigid core layer includes a composite portion. For example, the rigid core layer may include a sheet, mesh, or other woven or non-woven fiber reinforcement material. The composite may include a stabilizing matrix or other material such as a polymer matrix or one or more of the materials forming the rigid core layer. In other embodiments, the composite forms a portion of the flooring that is separate or external to the rigid core layer.

In some embodiments, the rigid core layer is between approximately 1.5 millimeters and approximately 6 millimeters. In some embodiments, the rigid core layer is annealed after extrusion. In some embodiments, layers 104, 108, 110, 102, and 112 are annealed after being connected together. In some embodiments, the annealing process includes one or more cooling and heating cycles. In some embodiments, the rigid core layer is stored in a temperature controlled area for between approximately 48 and approximately 72 to achieve balancing prior to being annealed.

In some embodiments, the rigid core layer is extruded in a sheet having width between approximately 1 meter and approximately 1.5 meters wide. In some embodiments, the extruded rigid core layer is cut down to one of a plurality of product sizes. For example, the product sizes may include approximately 12 inches by 24 inches, 6 inches by 48 inches, 12 inches by 12 inches, 18 inches by 18 inches, or other sizes.

In some embodiments, the rigid core layer achieves a minimal distortion. In one embodiment, a 240 mm square rigid core layer having a thickness of 3.3 mm experiences a manufacturing direction distortion of equal to or less than 0.04% or 0.0038 inches and an across manufacturing direction distortion of equal to or less than 0.03% or 0.00285 inches when subjected to 82° C. for 6 hours and 23° C. for 24 hours at 50% humidity. This provides stability two to three times more stable than comparable flooring products.

At block 504, the method 500 includes applying a wear layer, a film layer, and a balance layer to the rigid core layer to form a top portion. As described above, one or more of the described layers may be optional in some embodiments.

In some embodiments, the layers are laid up together and hot pressed together in a single operation. In other embodiments, one or more of the layers of the top portion are laid up and pressed or otherwise bonded to another layer in an operation separate from the application of another layer.

In some embodiments, the top portion is annealed after at least one of the wear layer, the film layer, and the top and bottom balance layers are applied to the rigid core layer. In some embodiments, the top portion is annealed prior to application of one or more of the wear layer, the film layer, and the top and bottom balance layers to the rigid core layer.

At block 506, the method 500 includes cutting the top portion to a product size. In some embodiments, one or more of the layers of the top portion are applied to another layer after the rigid core layer is cut to a product size. In some embodiments, one or more of the layer of the top portion are applied to another layer of the top portion before the rigid core layer is cut to a product size. In some embodiments, the top portion may be scored to facilitate separation into a product size at a later time.

At block 508, the method 500 includes applying an anti-slip layer to the top portion. In some embodiments, a lower balance layer is applied to the top portion and the anti-slip layer is applied to the lower balance layer. In other embodiments, the anti-slip layer includes a balance layer.

In some embodiments, the anti-slip layer is a relatively thin coating. The anti-slip coating may include a wet formulation, a raw film, or the like. In some embodiments, the anti-slip coating is applied via rolling, spraying, laying, or the like. In some embodiments, the anti-slip coating is applied as a final step in the assembly of the flooring product. In other embodiments, the anti-slip coating is applied as a first or intermediate step in which the anti-slip coating is applied to a component of the flooring before another assembly or finishing operation is carried out.

In some embodiments, the anti-slip coating is cured with a cold curing process. For example, the cold curing process may include a cold ultraviolet (UV) light curing process. In other embodiments, the anti-slip coating is cured with a warm or heated curing process. For example, the warm or heated curing process may include a warm or heated UV light curing process.

In some embodiments, the anti-slip layer provides an amount of cushioning. In some embodiments, the cushioning provides an increased safety measure against impacts or falls. For example, the cushioning may be useful in care centers or other environments in which falls may be anticipated. In some embodiments, the cushioning facilitates use in relatively high traffic areas to provide a softer underfoot feeling or reduce joint impact from traversing the floor.

In some embodiments, the anti-slip layer is flexible to accommodate an application surface that is not perfectly flat. In some embodiments, the anti-slip layer replaces or reduces the need for adhesives to secure the flooring in place. In some embodiments, the anti-slip layer replaces or reduces the need for interlocking structures to secure the flooring in place.

In some embodiments, the anti-slip layer is applied to an acoustic layer. In some embodiments, the acoustic layer provides sufficient sound insulation against impact and ambient noise to satisfy international building code requirements for sound transmission. In some embodiments, the anti-slip layer reduces or removes the need for separate acoustic underlayment such as a sound rated concrete or pad. This improves efficiency in installation and reduces cost. In some embodiments, the acoustic layer and the anti-slip layer are unified.

In some embodiments, the anti-slip layer is applied with an adhesive. In some embodiments, the adhesive is a hot adhesive that soft cures. In other embodiments, the adhesive is a cold adhesive that hard cures. In some embodiments, application of the anti-slip layer includes a pressing operation. In some embodiments, application of the anti-slip layer includes a heating operation. In some embodiments, the total thickness with the anti-slip layer applied is between approximately 4.2 and approximately 9 mm.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus comprising:
a loose-lay flooring comprising:
a rigid core;
a wear layer disposed on a first side of the rigid core; and
an anti-slip layer disposed on a second side of the rigid core.

2. The apparatus of claim 1, wherein the anti-slip layer comprises a urethane-based coating.

3. The apparatus of claim 2, wherein the anti-slip layer is applied via at least one of rolling, spraying, or laying.

4. The apparatus of claim 2, wherein the anti-slip layer is cured using a cold curing process.

5. The apparatus of claim 4, wherein the cold curing process comprises a cold ultraviolet light curing process.

6. The apparatus of claim 1, wherein the loose-lay flooring further comprises a composite layer.

7. The apparatus of claim 6, wherein the composite comprises a fiberglass.

8. The apparatus of claim 1, wherein the rigid core comprises one of a stone powder, calcium carbonate, poly-vinyl chloride, and pigments.

9. The apparatus of claim 1, wherein the loose-lay flooring comprises a straight edge.

10. The apparatus of claim 9, wherein the straight edge of the loose-lay flooring comprises an angle of approximately 10° from the anti-slip layer to the wear layer.

11. The apparatus of claim 1, further comprising a balance layer between the rigid core and the anti-slip layer, the balance layer to offset a physical characteristic of the wear layer.

12. The apparatus of claim 1, wherein the loose-lay flooring further comprises an acoustical layer.

13. The apparatus of claim 1, wherein the rigid core is an extruded material.

14. The apparatus of claim 1, wherein the anti-slip layer comprises a synthetic rubber.

15. The apparatus of claim 1, wherein the wear layer comprises one of a urethane, a ceramic bead, or aluminum oxide top finish.

16. A flooring apparatus comprising:
a loose-lay flooring comprising a tongue-and-groove arrangement, the loose-lay flooring further comprising:
a rigid core;
a wear layer disposed on a first side of the rigid core; and
an anti-slip layer disposed on a second side of the rigid core.

17. The flooring apparatus of claim 16, wherein the loose-lay flooring further comprises:
a film layer disposed between the wear layer and the rigid core;
an upper balance layer disposed between the film layer and the rigid core;
a lower balance layer disposed between the core and the anti-slip layer; and
an acoustic layer disposed between the lower balance layer and the anti-slip layer.

18. The flooring apparatus of claim 16, wherein the loose-lay flooring further comprises an adhesive.

19. A method comprising:
extruding a rigid core layer;
applying a wear layer, film layer, and a balance layer to the rigid core layer to form a top portion;
cutting the top portion to a product size; and
applying an anti-skid layer to the top portion.

20. The method of claim 19, wherein applying the anti-skid layer to the top portion comprises:
at least one of rolling, spraying, and laying the anti-skid layer onto the top portion; and
curing the anti-skid layer on the top portion.
